(19) United States
(12) Patent Application Publication
(10) Pub. No.: US 2011/0175448 A1
(43) Pub. Date: Jul. 21, 2011

(54) COMBINED WIRELESS BRIDGE AND SURGE PROTECTED POWER STRIP

(76) Inventors: Mark Engler, Pasadena, CA (US); Huan Yu Hu, Chino Hills, CA (US)

(21) Appl. No.: 12/688,889

(22) Filed: Jan. 17, 2010

(51) Int. Cl. H02J 3/14

(52) U.S. Cl. 307/38

(57) ABSTRACT

The present invention is directed toward a combined wireless bridge and power strip including a housing defining an interior and an exterior. A power cord is coupled to the housing. A power surge protector coupled to the power cord is disposed in the housing. An electrical power switch is coupled to the surge protector and is disposed in the housing. An array of electrical outlets is coupled to the electrical power switch and is disposed in the housing in operative communication between the interior and the exterior. A power transformer is coupled to the power surge protector in the housing interior. A wireless bridge is coupled to the power transformer and can be disposed in the housing interior or on its exterior. The wireless bridge includes one or more ports to provide entry points for devices requiring wired LAN entry points.

### REFERENCE TO PENDING APPLICATIONS

This application is not based on any pending patent application.

### BACKGROUND OF THE INVENTION

The present invention is generally directed to the field of transforming a wireless network connection into a wired network operative connection and power supply. In particular, the disclosure relates to a combined wireless bridge and power strip for combining wireless network connections and electrical power supply for Ethernet ready/enabled devices. Moreover the present invention utilizes a system to automatically power down the wireless bridge when the host device such as a television is turned off thereby saving energy.

Many devices, such as Blue-Ray players, video game consoles, DVD players, and TV sets, can accept a wired Ethernet connection. However most homes do not have Ethernet cable running to the area where the television set is placed. Individuals have to purchase a device known as a wireless bridge to convert the wireless signal to a wired signal that can then be plugged into the Ethernet connection on these devices. This wireless bridge must be plugged into a power strip, taking up another space on the power strip. While new devices are being made with wireless connection points built in, the vast majority of home entertainment devices installed lack such a connection. The expansion of offerings for video on the internet & some intranets point to the need for a device that will allow the wireless connection to be transferred to a wired LAN in an economical method.

The term wireless bridge is used herein to define a piece of hardware that allows for the propagation of data across a device without traversing a network stack, such as TCP/IP. In other words, it is directed to a device that allows information packets to traverse from a wireless to wired network without passing through an internal protocol stack, firewall or other network abstraction. This would allow two bridged networks to be treated as parts of a single subnet under Internet Protocol (IP), further allowing a wireless client to be able to make a DHCP request from a wired server.

The prior art system requires a power strip having a separate wireless bridge connected thereto which obstructs free space and can be easily unplugged. The prior art system is not practical in the home environments, where space is always a premium. Most home environments lack space for plugging even one more device into a power strip.

What is needed in the art is a unitary combined wireless bridge and power strip for transforming a wireless network communication into a wired network operative communication with the stability of a combined electrical power supply to connect internet/intranet signals to Ethernet ready/enabled devices.

### BRIEF SUMMARY OF THE INVENTION

The present invention satisfies the needs discussed above. The present invention is generally directed toward the field of transforming a wireless network connection into a wired network operative connection and power supply. In particular, the disclosure relates to a combined wireless bridge and power strip for combining wireless network connections and electrical power supply for Ethernet ready/enabled devices.

One aspect of the disclosed device is directed towards a combined wireless bridge and surge protected power strip including a housing defining an interior and an exterior. A power cord is coupled to the housing. A power surge protector coupled to the power cord is disposed in the housing. An electrical power switch is coupled to the surge protector and is disposed in the housing. An array of electrical outlets is coupled to the electrical power switch and is disposed in the housing in operative communication between the interior and the exterior. A power transformer is coupled to the power surge protector in the housing interior. A wireless bridge is coupled to the surge protected power strip and draws power therefrom. The wireless bridge includes a minimum of one LAN port and can contain one or more ports to provide entry points for devices requiring wired LAN entry points.

Another aspect of the present invention discloses a combined wireless bridge and surge protected power strip wherein the power strip includes a master power plug. The master plug is used to power a piece of electronic equipment, such as a television or computer, which is referred to as the “master device”. When the “master device” is turned off; the present invention detects the drop in the power current used by the master device and then begins a process to shut off the power provided to the wireless bridge. This shutdown can occur either simultaneously with the shut off of the power to the “master device” or after a delay in time, which delay can be set at any length, such as 30, 60, 90 or more seconds.

A microprocessor monitors the power levels of the device in the “master” outlet. In this embodiment, the microprocessor measures the wattage being used by the various devices connected to the power strip. The power levels are then digitally calculated by the microprocessor based on the wattage values.

Another aspect of the present invention discloses a combined wireless router and surge protected power strip. This aspect is similar to the above aspects and further include a wireless router in the place of the wireless bridge.

Upon reading the above description, various alternative embodiments will become obvious to those skilled in the art. These embodiments are to be considered within the scope and spirit of the subject invention, which is only to be limited by the claims which follow and their equivalents.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

### BRIEF DESCRIPTION OF THE DRAWINGS

FIG. 1 is a schematic of an exemplary combined wireless bridge and surge protected power strip coupled to a Local Area Network in accordance with the first embodiment of the invention.

FIG. 2 is a schematic of an exemplary combined wireless bridge and surge protected power strip.

FIG. 3 is a schematic of exemplary view combined wireless bridge and surge protected power strip coupled to a Local Area Network in accordance with the second embodiment of the invention.

FIG. 4 is a schematic of a third embodiment of the invention.

### DETAILED DESCRIPTION OF THE INVENTION

The attached drawing demonstrates an embodiment of the present invention. It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

The disclosure describes an exemplary combined wireless bridge and power strip. The combined wireless bridge and power strip includes a housing containing a power transformer coupled to a power feed. A surge protector is coupled to the power transformer and array of electrical outlets and is configured to disconnect the electrical power responsive to a predetermined power surge. The power transformer supplies electrical power to a wireless bridge. The wireless bridge includes one or more ports. Devices requiring wired LAN entry points can be coupled to the wireless bridge through the one or more ports. These devices can include receiving data from both Internet and Intranet sources, for example receiving video from a wireless network that can be transformed to exist on a home entertainment system.

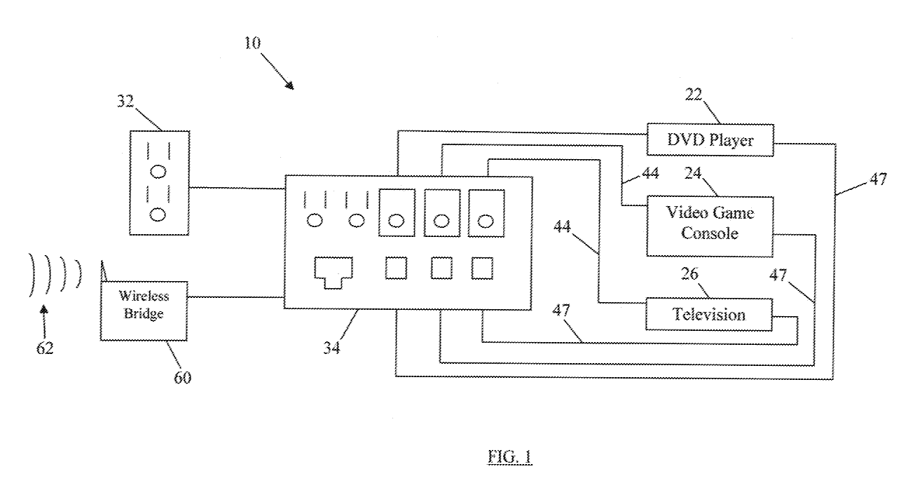

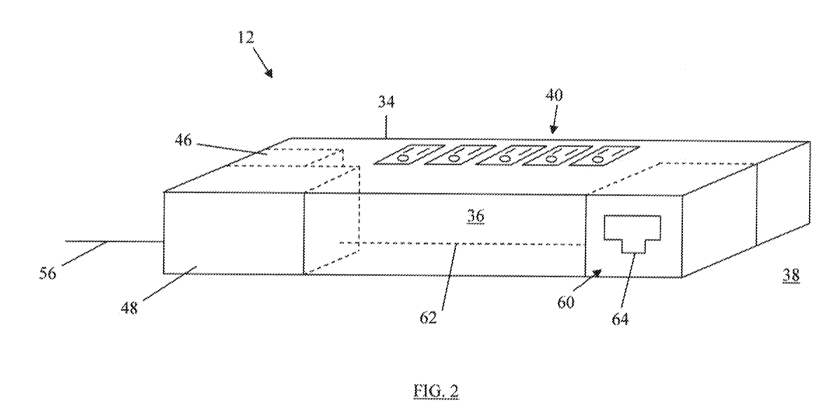

Referring to FIGS. 1 and 2, an embodiment 10 of a schematic of an exemplary combined wireless bridge and power strip 30 coupled to a plurality of Ethernet ready/enabled devices 20 and a perspective view of an exemplary combined wireless bridge and power strip 12 are illustrated respectively. The Ethernet ready/enabled devices 20 include electronic components such as a Blue-Ray player 22, a video game console 24, and a TV set 26. One skilled in the art will recognize that the use of these devices is for illustrative purposes and is not meant to be limiting.

A combined wireless bridge and power strip 30 is coupled between the Ethernet ready/enabled devices 20 and the electrical power outlet 32. The combined wireless bridge and power strip 30 comprises a housing 34 defining an interior 36 and an exterior 38. An array of electrical outlets 40 is disposed in the housing 34 and communicates between the interior 36 and exterior 38. The array of electrical outlets 40 is configured to receive electrical power cords 44 to supply electrical power to the Ethernet ready/enabled devices 20. The array of electrical outlets 40 can comprise two (2) outlets and more in other exemplary embodiments. The array of electrical outlets 40 can provide any style of electrical power, such as US/110, European, Australian and the like. The array of electrical outlets 40 is coupled to an electrical power switch 42 and power surge protector 46.

The electrical power switch 42 is configured to control electrical power to the array of electrical outlets 40. The electrical power switch 42 is disposed in the housing 34 and exposed to the exterior 38. In an exemplary embodiment, the electrical power switch 42 can be a lighted toggle switch. The power surge protector 46 is configured to limit electrical surge through the combined wireless bridge and power strip 30. The power surge protector 46 can comprise a circuit breaker or a fuse disposed in the interior 36 of the housing 34. A power cord 56 is coupled to the power surge protector 46 and a power transformer 48. The power cord 56 extends from the housing 34 and is coupled to the electrical power outlet 58 opposite the power surge protector 46. The power transformer 48 is disposed in the interior 36 of the housing 34. The power transformer 48 conditions the electrical power supply from the power cord 56 (e.g., AC to DC power).

A wireless bridge 60 is coupled to housing 30 and receives power from power transformer 48 through a DC (direct current) power bus 62. The wireless bridge 60 receives wireless transmissions 62 and includes a LAN entry point port 64. LAN entry point port 64 provide network communication to Ethernet ready/enabled devices 20 through a wired network 47.

In use, the combined wireless bridge and power strip provides a link between a wireless network communication and a power supply that can be used with devices that require a wired network communication. The combined wireless bridge and power strip protects the Ethernet ready/enabled devices from power surges through the electrical power switch and electrical power surge protector. The combined wireless bridge and power strip conditions the electrical power with the power transformer to provide DC electrical power to the Ethernet ready/enabled devices. The combined wireless bridge and power strip provides a compact uniform package for transforming a wireless network connection into a wired network operative connection.

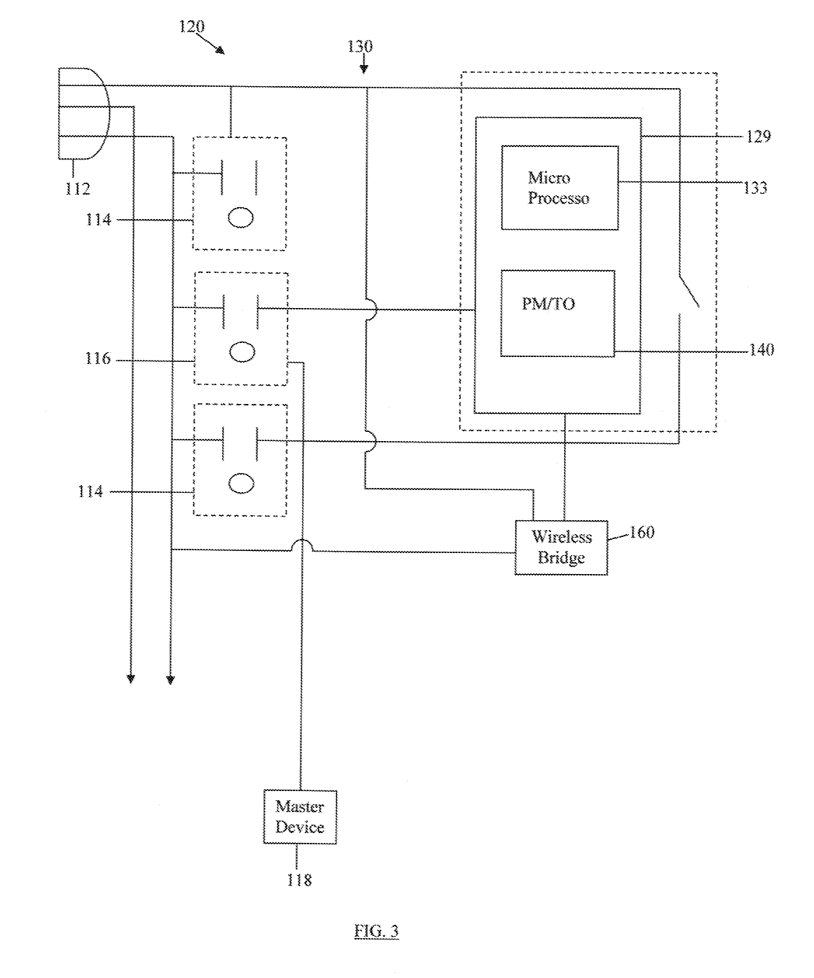

As shown in FIG. 3, a second embodiment 100 of a schematic of an exemplary combined wireless bridge and power strip coupled to a plurality of Ethernet ready/enabled devices 120 is illustrated. The combined wireless bridge and power strip 130 are coupled in the same manner as described with respect to the above embodiment 10. Power strip 130 includes a master power outlet 116 for connecting to a master device 118, such as a television. A computer component 129 which can learn various settings and data associated with various master device 118 in included with power strip 130. In this embodiment, computing component 129 includes microprocessor 133 that is used for determining when a wattage level associated with the power across the master power outlet 116 falls below or rises above a threshold in response to the master device 118 being turned on and off. The computer component 129 can include a power modulating/timing delay component 140 for interrupting a power supply on a time delay basis to wireless bridge 160 when microprocessor 133 digitally calculates that the wattage levels of master power outlet 116 has fallen below a threshold value. Microprocessor 133 calculates the wattage levels by a series of computations. One such computation is based on the amount of current and voltage that flows across the master power outlet 116.

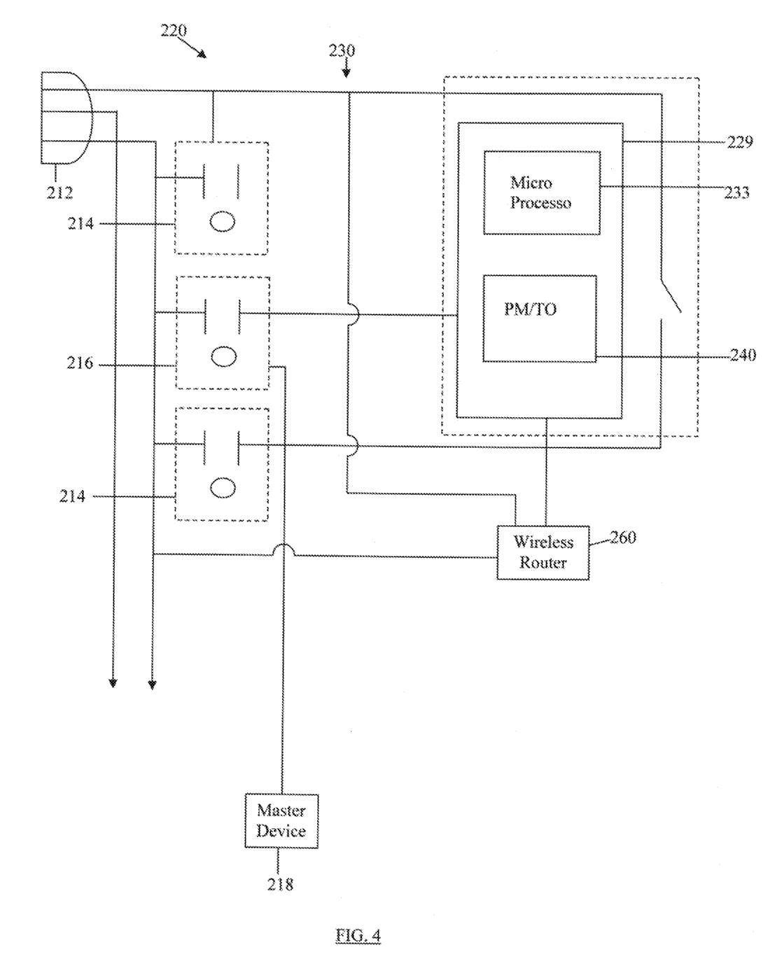

As shown in FIG. 4, a third embodiment 200 of the present invention is illustrated. The combined wireless router and power strip 230 are coupled in the same manner as described with respect to the above embodiment 10. Power strip 230 includes a master power outlet 216 for connecting to a master device 218, such as a television. A computer component 229 which can learn various settings and data associated with various master device 218 in included with power strip 230. In this embodiment, computing component 229 includes microprocessor 233 that is used for determining when a wattage level associated with the power across the master power outlet 216 falls below or rises above a threshold in response to the master device 218 being turned on and off. The computer component 229 can include a power modulating/timing delay component 240 for interrupting a power supply on a time delay basis to wireless router 260 when microprocessor 233 digitally calculates that the wattage levels of master power outlet 116 has fallen below a threshold value. Microprocessor 133 calculates the wattage levels by a series of computations. One such computation is based on the amount of current and voltage that flows across the master power outlet 216.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

What is claimed is:

1. A combined wireless bridge and power strip comprising:
a housing defining an interior and an exterior;
a power cord coupled to said housing;
a power surge protector disposed in said housing interior and coupled to said power cord;
an electrical power switch coupled to said surge protector and disposed in said housing in operative communication between said interior and said exterior;
an array of electrical outlets coupled to said electrical power switch and disposed in said housing in operative communication between said interior and said exterior;
a power transformer coupled to said power surge protector and disposed in said housing interior;
a wireless bridge is coupled to said power transformer and is disposed in said housing interior, said wireless bridge includes one or more ports to provide entry points for devices requiring wired LAN entry points.

2. The combined wireless bridge and power strip of claim 1 wherein said wireless bridge is disposed on the exterior of said housing.

3. The combined wireless bridge and power strip of claim 1 wherein said power surge protector comprises one of a circuit breaker and a fuse.

4. The combined wireless bridge and power strip of claim 1 wherein said power surge protector comprises one of a circuit breaker and a fuse.

5. The combined wireless bridge and power strip of claim 1 wherein said power transformer is configured to condition electrical power from an alternating current to a direct current.

6. The combined wireless bridge and power strip of claim 1 wherein said power transformer is coupled to said network switch through a DC power bus.

7. The combined wireless bridge and power strip of claim 1 wherein said power strip comprises:
a master power outlet to be connected to a master device;
a computing component, said computing component determining when the wattage level associated with the master power outlet falls below a threshold in response to said master device being turned off, said computing component interrupting a power supply on a time delay basis to said wireless bridge when said computing component determines the wattage level falls below said threshold.

8. The combined wireless bridge and power strip of claim 7, wherein said computing component includes a microprocessor, said microprocessor determining said wattage level associated with the master power outlet.

9. The combined wireless bridge and power strip of claim 7, wherein said computing component includes a power modulating/timing delay subcomponent, said power modulating/timing delay subcomponent interrupting a power supply on a time delay basis to said wireless bridge when said computing component determines the wattage level associated with said master power outlet falls below said threshold.

10. The combined wireless bridge and power strip of claim 7, wherein said computing component determines said wattage level by calculating the current and voltage across said master power outlet.

11. A combined wireless router and power strip comprising:
a housing defining an interior and an exterior;
a power cord coupled to said housing;
a power surge protector disposed in said housing interior and coupled to said power cord;
an electrical power switch coupled to said surge protector and disposed in said housing in operative communication between said interior and said exterior;
an array of electrical outlets coupled to said electrical power switch and disposed in said housing in operative communication between said interior and said exterior;
a power transformer coupled to said power surge protector and disposed in said housing interior;
a wireless router is coupled to said power transformer and is disposed in said housing interior, said wireless router includes one or more ports to provide entry points for devices requiring wired LAN entry points.
